(19) United States
(12) Patent Application Publication
(10) Pub. No.: US 2010/0292992 A1
(43) Pub. Date: Nov. 18, 2010

(54) METHOD AND APPARATUS FOR MULTIPLEX SIGNAL DECODING

(75) Inventor: Hau-Han Lee, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: RICHWAVE TECHNOLOGY CORP., Taipei (TW)

(21) Appl. No.: 12/581,250

(22) Filed: Oct. 19, 2009

(30) Foreign Application Priority Data
May 13, 2009 (TW) 98115791

(51) Int. Cl. G10L 19/00; H04H 20/88

(52) U.S. Cl. 704/500; 381/2; 704/E19.001

(57) ABSTRACT

A stereo audio decoder decoding a multiplex signal into a stereo audio signal. A first filter module filters the multiplex signal to generate a summation signal. A sub-carrier module modulates the multiplex signal according to a sub-carrier frequency to generate a sub-carrier mixed signal having a first high frequency and a first low frequency component. The first low frequency component has a sub-carrier phase offset between the stereo audio decoder and the multiplex signal. The second filter module filters out the first high frequency component of the sub-carrier mixed signal to generate a sub-carrier pure signal having only the first low frequency component. A corrector generates a difference signal according to a correction signal and the multiplex signal. A channel separator obtains a left channel signal and a right channel signal of the stereo audio signal by decoding the summation signal and the difference signal.

### CROSS REFERENCE TO RELATED APPLICATIONS

This Application claims priority of Taiwan Patent Application No. 098115791, filed on May 13, 2009, the entirety of which is incorporated by reference herein.

### BACKGROUND OF THE INVENTION

1. Field of the Invention

The invention relates to a method and apparatus for stereo audio decoding, and more particularly to a technique for decoding a stereo audio from a multiplex signal.

2. Description of the Related Art

FIG. 1 shows a block diagram of a conventional stereo audio decoder 100. As defined by the wireless broadcasting standards, a stereo audio signal including a left channel signal L and a right channel signal R is a transmitted in a form of a multiplex signal MPX modulated by a broadcast station or a transmitter. In order to recover the left channel signal L and the right channel signal R in the receiver, the formula of the multiplex signal MPX is defined as below:

MPX=(L+R)+(L−R)sin 2ωₚt+V(L−R)sin ωₚt Eq. (1)

where the left channel signal L and the right channel signal R respectively represent the left channel baseband signal and the right channel baseband signal, 2ωₚ represents the sub-carrier frequency, ωₚ represents the pilot frequency, which is half of the sub-carrier frequency, and V represents the amplitude of the pilot signal. Since the pilot frequency ωₚ is a known value, the receiver is able to recover the difference signal (L−R) by a predetermined demodulation scheme.

However, in actual transmission environments, the signals are not perfectly received by the receiver. Further, the pilot frequency ωₚ generated by the receiver may not be exactly the same as the pilot frequency generated at the transmitter side. Therefore, demodulation error exists. When taking the frequency mismatch between the transmitter and receiver into consideration, the received multiplex signal MPX may be expressed as:

MPX=(L+R)+(L−R)sin(2ωₚt+2α)+V sin(ωₚt+α) Eq. (2)

where α represents the phase difference of the multiplex signal MPX with respect to the pilot frequency, and the phase difference with respect to the sub-carrier frequency is 2α. When the multiplex signal MPX is input to the audio receiver 100 as shown in FIG. 1, the left channel signal L and the right channel signal R are recovered by several demodulation steps. The audio receiver 100 comprises a sub-carrier module 106, providing the sub-carrier frequency 2ωₚ for demodulating the multiplex signal MUX. To be more specific, the sub-carrier module 106 multiplies the multiplex signal MPX by a sine wave and a cosine wave having the sub-carrier frequency 2ωₚ to generate an in phase sub-carrier mixed signal MSI and a quadrature phase sub-carrier mixed signal MSQ, respectively. The in phase sub-carrier mixed signal MSI and the quadrature phase sub-carrier mixed signal MSQ are expressed as below:

MSI=MPX*sin 2ωₚt=½(difference signal (L−R))*cos 2α+ Eq. (3)

MSQ=MPX*cos 2ωₚt=½(difference signal (L−R))*sin 2α+ Eq. (4)

wherein only the frequency components at the frequency 2α are shown in equations (3) and (4). The high frequency components are omitted in equations (3) and (4) because they will be eliminated in the following described process.

In addition, the audio receiver 100 further comprises a pilot module 102, which is similar to the sub-carrier module 106 but different in that it provides the pilot frequency ωₚ for demodulating the multiplex signal MUX. In other words, the pilot module 102 multiplies the multiplex signal MPX by a sine wave and a cosine wave having the sub-carrier frequency ωₚ to generate a pair of in phase pilot mixed signal MPI and quadrature phase pilot mixed signal MPQ, respectively. The in phase pilot mixed signal MPI and the quadrature phase pilot mixed signal MPQ are expressed as below:

MPI=MPX*sin ωₚt=V*cos α+ Eq. (5)

MPQ=MPX*cos ωₚt=V*sin α+ Eq. (6)

Similarly, the high frequency components are omitted in equations (5) and (6). Next, the in phase pilot mixed signal MPI and the quadrature phase pilot mixed signal MPQ are transmitted to the third filter module 104 to filter out the high frequency components that are not shown in the above equations and output the in phase pilot signal #PI and the quadrature phase pilot signal #PQ having only the pilot frequency components as:

#PI=V*cos α Eq. (7)

#PQ=V*sin α Eq. (8)

Next, the in phase pilot signal #PI and the quadrature phase pilot signal #PQ are transmitted to an error estimator 110 to estimate the phase offset α. To be more specific, the error estimator 110 obtains the values of cos 2α and sin 2α as follows:

Assuming that A=V², which represents the pilot signal quality, then:

A=(V*cos α)²+(V*sin α) Eq. (9)

A cos 2α=(V*cos α)−(V*sin α) Eq. (10)

A sin 2α=(V*cos α)*(V*sin α) Eq. (11)

In order to obtain the values of cos 2α and sin 2α, the term A in equation (9) has to be eliminated. In the conventional technique, as recited in the U.S. Pat. No. 5,442,709, the values obtained through equations (10) and (11) are converged by performing a dynamic average algorithm once to generate the terms cos 2α and sin 2α. Finally, the error estimator 110 passes the values of cos 2α and sin 2α as the correction signal #ERR to the corrector 108. The corrector 108 processes the in phase sub-carrier mixed signal MSI and the quadrature phase sub-carrier mixed signal MSQ received from the sub-carrier module 106 according to the correction signal #ERR to generate the difference signal (L−R). Next, the channel separator 112 coupled to an output of the corrector 108 computes the left channel mixed signal #L and the right channel mixed signal #R according to the difference signal (L−R) and the multiplex signal MPX. Finally, the low pass filter (LPF) 114 filters out the high frequency components of the left channel mixed signal #L and the right channel mixed signal #R to output the correct left channel signal L and the right channel signal R.

Conventionally, only the situation when the phase offset α exists is considered. However, in addition to the phase offset, frequency offset or timing offset between the multiplex signal MPX and the audio receiver 100 may also exist. Therefore, error may still occur when the conventional method is implemented. Further, when the conventional error estimator 110 estimates the phase offset, the amount of time needed is proportional to a more precise convergence result, which becomes a bottleneck when designing and considering overall performance of the stereo signal decoding. Undesired high frequency noise exists in the in phase sub-carrier mixed signal MSI and the quadrature phase sub-carrier mixed signal MSQ computed by the sub-carrier module 106. Thus, when the corrector 108 processes the in phase sub-carrier mixed signal MSI and the quadrature phase sub-carrier mixed signal MSQ according to the correction signal #ERR, the generated difference signals (L−R) are inevitably interfered with by noise. Although the LPF 114 in the last stage of the decoder can filter out the high frequency noise before outputting the left channel signal L and the right channel signal R, the overall delay degrades overall signal streaming efficiency. In conclusion, there are areas for improvement needed for the conventional multiplex signal decoding circuit.

### BRIEF SUMMARY OF THE INVENTION

Stereo audio decoders and multiplex signal decoding methods are provided. An exemplary embodiment of a stereo audio decoder for decoding a multiplex signal into a stereo audio signal comprises a first filter module, a sub-carrier module, a second filter module, a corrector and a channel separator. The first filter module filters the multiplex signal to generate a summation signal. The sub-carrier module modulates the multiplex signal according to a sub-carrier frequency to generate a sub-carrier mixed signal comprising a first high frequency component and a first low frequency component. The first low frequency component comprises a sub-carrier phase offset between the stereo audio decoder and the multiplex signal. The second filter module is coupled to the sub-carrier module and filters out the first high frequency component of the sub-carrier mixed signal to generate a sub-carrier pure signal comprising only the first low frequency component. The corrector generates a difference signal according to a correction signal and the multiplex signal. The channel separator is coupled to the first filter module and the corrector and obtains a left channel signal and a right channel signal of the stereo audio signal by decoding the summation signal and the difference signal.

An exemplary embodiment of a multiplex signal decoding method for decoding a multiplex signal comprising a baseband signal component, a sub-carrier signal component and a pilot signal component into a stereo audio signal comprises: low pass filtering the multiplex signal to generate a summation signal comprising only the baseband signal component; modulating the multiplex signal according to a sub-carrier frequency to generate a sub-carrier mixed signal comprising a first high frequency component and a first low frequency component, wherein the first low frequency component comprises a sub-carrier phase offset between the sub-carrier signal component and the sub-carrier frequency; filtering out the first high frequency component to generate a sub-carrier pure signal comprising only the first low frequency component; eliminating the sub-carrier phase offset of the sub-carrier pure signal according to a correction signal to generate a difference signal; and obtaining a left channel signal and a right channel signal by decoding the stereo audio signal according to the summation signal and the difference signal.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of a conventional stereo audio decoder;

FIG. 2 is a block diagram showing a stereo audio decoder according to an embodiment of the invention;

FIG. 3 shows block diagrams of the sub-carrier module and the second filter module according to an embodiment of the invention;

FIG. 4 shows block diagrams of the pilot module 102 and the third filter module 104 according to an embodiment of the invention;

FIG. 5 shows block diagrams of the corrector 108 and the channel separator 112 according to an embodiment of the invention; and

FIG. 6 shows a flow chart of a multiplex signal decoding method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

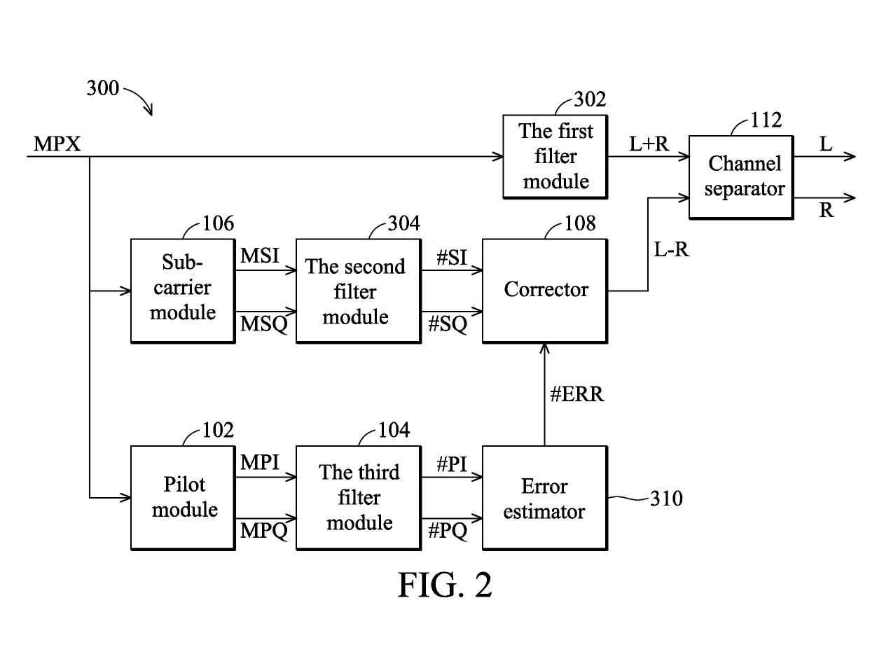

FIG. 2 is a block diagram showing a stereo audio decoder 300 according to an embodiment of the invention. In the proposed stereo audio decoder, improvements upon conventional decoder are mainly focused on the disposition of the first filter module 302, the second filter module 304 and the error estimator 310. In order to recover the left channel signal L and the right channel signal R more precisely from the multiplex signal MPX, in addition to the phase offset a, the frequency offset and the timing offset are further taken into consideration in the decoder design. Therefore, the model of the multiplex signal MPX may be expressed as below:

MPX=(L+R)+(L−R)sin(2(ωₚ₊ωₚ)(t+t)+2α)+V sin((ωₚ₊ωₚ)(t+t)+α) Eq. (12)

where ωₚ represents the frequency offset and t represents the timing offset. When expanding Eq. (12), the equation may be further simplified as:

MPX=(L+R)+(L−R)sin(2ωₚt+2γ)+V(L−R)sin(ωₚt+γ) Eq. (13)

where γ represents a collection of the sundries regarding ωₚ, t and α, standing for a physical quantity concerning all of the frequency, timing and phase offset. Detailed results for expanding of Eq. (12) are not shown since the term y may be eliminated in the following described operations.

The multiplex signal MPX is passed to the first filter module 302, the sub-carrier module 106 and the pilot module 102 after being input to the stereo audio decoder 300. After the computations of the pilot module 102, the third filter module 104 and the error estimator 310, a pair of correction signals #ERR may be generated to correct the in phase sub-carrier pure signal #SI and the quadrature phase sub-carrier pure signal #SQ generated by the sub-carrier module 106 and the second filter module 304, and finally obtain the difference signal (L−R). The first filter module 302 filters out the baseband component shown in Eq. (13), which is the summation signal (L+R). Finally, the channel separator 112 processes the summation signal (L+R) generated by the first filter module 302 and the difference signal (L−R) generated by the corrector 108 to precisely separate the left channel signal L and the right channel signal R.

The sub-carrier module 106 provides a sub-carrier frequency 2ωₚ to demodulate the multiplex signal MPX into an in phase sub-carrier mixed signal MSI and a quadrature phase sub-carrier mixed signal MSQ, expressed as below:

MSI=MPX*sin 2ωₚt=½(L−R)*cos 2γ+ Eq. (14)

MSQ=MPX*cos 2ωₚt=½(L−R)*sin 2γ+ Eq. (15)

Similar to Eq. (3) and Eq. (4), the Eq. (14) and Eq. (15) lists only the frequency component at frequency 2γ. The high frequency components are omitted in the equations because they will be eliminated in the following described process.

A second filter module 304 is coupled to the sub-carrier module 106 to filter out the not-shown high frequency components in Eq. (14) and Eq. (15) and output an in phase sub-carrier pure signal #SI and a quadrature phase sub-carrier pure signal #SQ having only the frequency components at frequency 2γ as expressed below:

#SI=½(L−R)*cos 2γ Eq. (16)

#SQ=½(L−R)*sin 2γ Eq. (17)

Similar to the sub-carrier module 106 and the second filter module 304, the pilot module 102 and the third filter module 104 also provide a pilot frequency ωₚ to demodulate the multiplex signal MPX. The pilot module 102 generates an in phase pilot mixed signal MPI and a quadrature phase pilot mixed signal MPQ as:

MPI=MPX*sin ωₚt=V*cos γ+ Eq. (18)

MPQ=MPX*cos ωₚt=V*sin γ+ Eq. (19).

Next, the third filter module 104 filters out the high frequency components not listed in Eq. (18) and Eq. (19) and outputs the in phase pilot pure signal #PI and quadrature phase pilot pure signal #PQ as:

#PI=V*cos γ Eq. (20)

#PQ=V*sin γ Eq. (21)

The in phase pilot pure signal #PI and quadrature phase pilot pure signal #PQ as shown in Eq. (20) and Eq. (21) are passed to the error estimator 310 to obtain the correction signals # ERR. To be more specific, the correction signals # ERR are cos 2γ and sin 2γ, utilized to correct the in phase sub-carrier pure signal #SI and the quadrature phase sub-carrier pure signal #SQ generated by the second filter module 304. In order to obtain the cos 2γ and sin 2γ, a variable A=V² is defined to represent the pilot signal quality. Therefore, it is obtained that a sum of the squares of the in phase pilot pure signal #PI and the quadrature phase pilot pure signal #PQ equals to A as derived below:

(V*cos γ)²+(V*sin γ)²=A Eq. (22)

Meanwhile, the error estimator 310 obtains a difference between the squares of the in phase pilot pure signal #PI and the quadrature phase pilot pure signal #PQ as:

(V*cos γ)²−(V*sin γ)²=A cos 2γ Eq. (23)

According to Eq. (22) and Eq. (23), it is derived that:

cos 2γ=(V*cos γ)²/A−(V*sin γ)²/A Eq. (24)

In order to obtain the value of sin 2γ, the error estimator 310 computes products of the in phase pilot pure signal #PI and the quadrature phase pilot pure signal #PQ as below:

(V*cos γ)*(V*sin γ)=A sin 2γ Eq. (25)

Therefore, the value of sin 2γ may be obtained by dividing A from Eq. (25).

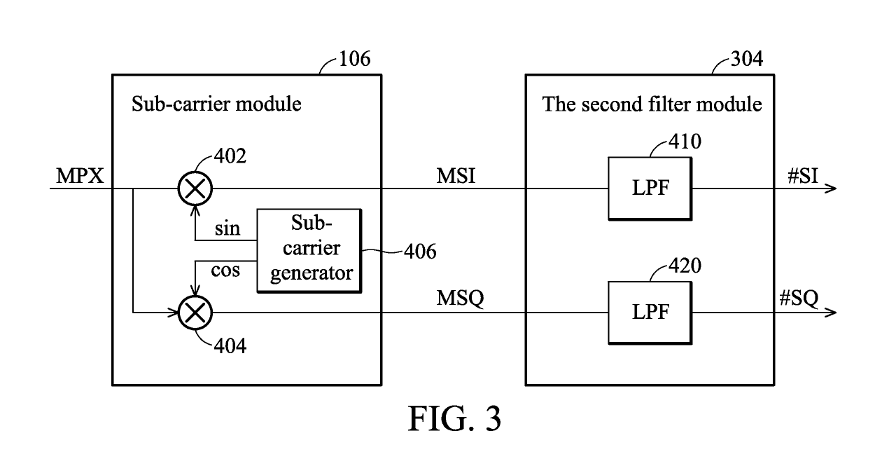

FIG. 3 shows block diagrams of the sub-carrier module 106 and the second filter module 304 according to an embodiment of the invention. The sub-carrier module 106 is comprised by a sub-carrier generator 406 and two multipliers 402 and 404. The sub-carrier generator 406 generates a sine signal and a cosine signal having the sub-carrier frequency 2ωₚ and the multipliers 402 and 404 operates according to the equations shown in Eq. (14) and Eq. (15). The second filter module 304 comprises two low pass filters 410 and 420 to low pass filter the in phase sub-carrier mixed signal MSI and the quadrature phase sub-carrier mixed signal MSQ generated by the sub-carrier module 106 and generate the in phase sub-carrier pure signal #SI and the quadrature phase sub-carrier pure signal #SQ as show in Eq. (16) and Eq. (17).

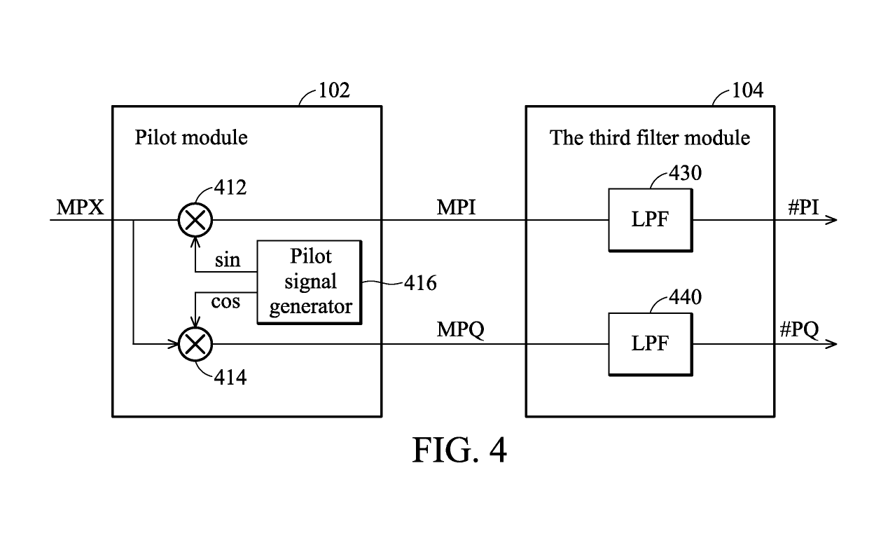

FIG. 4 shows block diagrams of the pilot module 102 and the third filter module 104 according to an embodiment of the invention. The block diagrams shown in FIG. 4 are similar to those shown in FIG. 3, but is different when processing the pilot signal component of the multiplex signal MPX. The pilot module 102 is comprised by a pilot signal generator 416 and two multipliers 412 and 414. The pilot signal generator 416 generates a sine signal and a cosine signal having the pilot frequency ωₚ and the multipliers 412 and 414 operate according to the equations shown in Eq. (18) and Eq. (19). The third filter module 104 comprises two low pass filters 430 and 440 to low pass filter the in phase pilot mixed signal MPI and the quadrature phase pilot mixed signal MPQ generated by the pilot module 102 and generate the in phase pilot pure signal #PI and the quadrature phase pilot pure signal #PQ as show in Eq. (20) and Eq. (21).

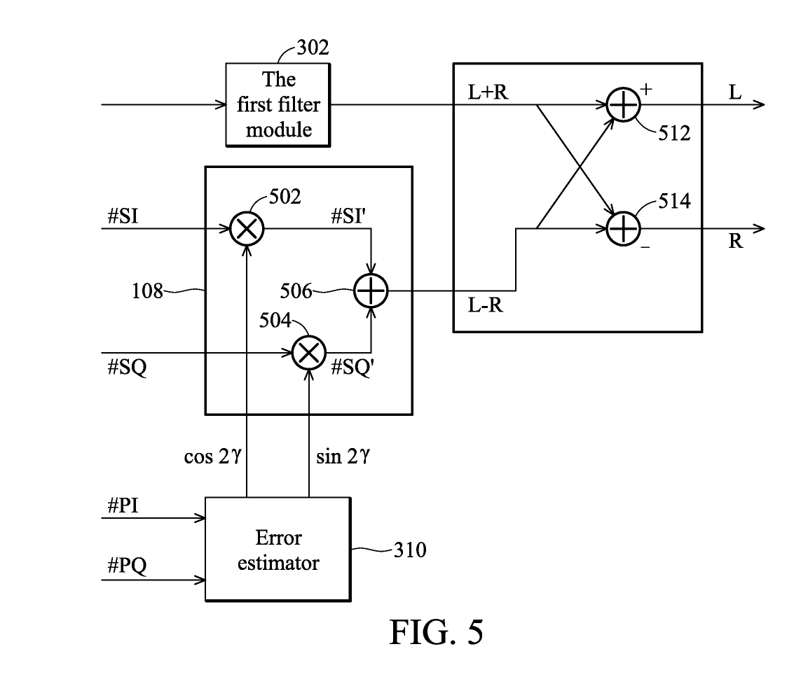

FIG. 5 shows block diagrams of the corrector 108 and the channel separator 112 according to an embodiment of the invention. The correction signals #ERR generated by the error estimator 310 are cos 2γ and sin 2γ. In the corrector 108, the in phase sub-carrier pure signal #SI and the quadrature phase sub-carrier pure signal #SQ received from the second filter module 304 are multiplied by the cos 2γ and sin 2γ via the multipliers 502 and 504 to generate an in phase sub-carrier compensation signal #SI′ and a quadrature phase sub-carrier compensation signal #SQ′:

#SI′=½(L−R)*cos 2γ**cos 2γ Eq. (26)

#SQ′=½(L−R)*sin 2γ·sin 2γ Eq. (27)

Next, the in phase sub-carrier compensation signal #SI′ and the quadrature phase sub-carrier compensation signal #SQ′ are added by the adder 506 to obtain the difference signal (L−R):

½(L−R)*cos 2γ**cos 2γ+½(L−R)*sin 2γ·sin 2γ=½(L−R) Eq. (28).

The channel separator 112 comprises an adder 512 and a subtractor 514. The summation signal (L+R) generated by the first filter module 302 and the difference signal (L−R) generated by the corrector 108 are summed and subtracted by the adder 512 and the subtractor 514, respectively, to generate the left channel signal L and the right channel signal R as:

L+R+(L−R)=2L Eq. (29)

L+R−(L−R)=2R Eq. (30).

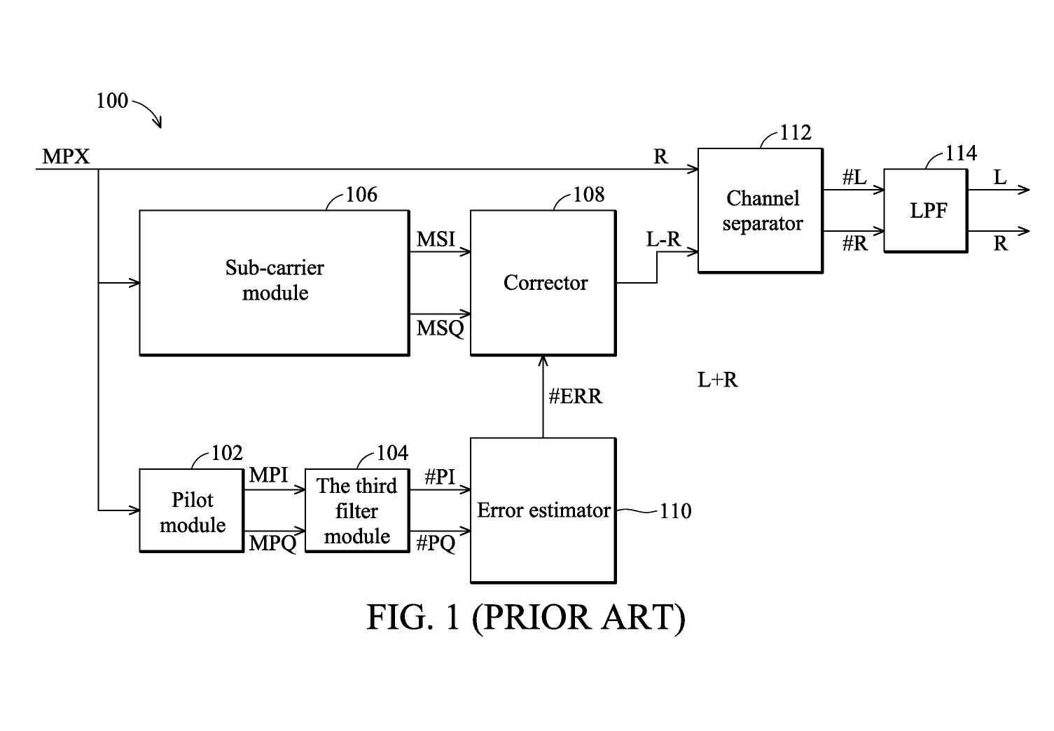

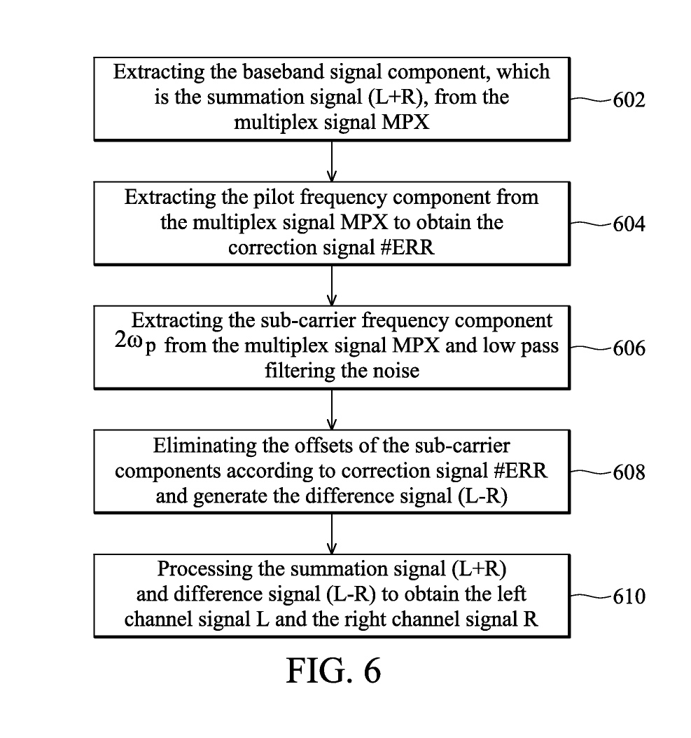

FIG. 6 shows a flow chart of a multiplex signal decoding method based on the stereo audio decoder 300 according to an embodiment of the invention. The multiplex signal decoding method comprises several steps. In step 602, the baseband signal component, which is, the summation signal (L+R), is extracted from the multiplex signal MPX. In step 604, the pilot frequency component ωₚ is extracted from the multiplex signal MPX to obtain the correction signal #ERR. In step 606, the sub-carrier frequency component 2ωₚ is extracted from the multiplex signal MPX and the noise is filtered out by the low pass filter to obtain the in phase sub-carrier pure signal #SI and the quadrature phase sub-carrier pure signal #SQ. In step 608, the in phase sub-carrier pure signal #SI and the quadrature phase sub-carrier pure signal #SQ are multiplied by the correction signal #ERR to eliminate the offsets and generate the difference signal (L−R). In step 610, the summation signal (L+R) and difference signal (L−R) are processed to obtain the left channel signal L and the right channel signal R. According to the embodiments of the invention, additional low pass filters 302 and 304 are utilized to filter out the undesired high frequency components before generating the summation signal (L+R) and the difference signal (L−R). The overall performance is improved as compared to the conventional method. In addition, the proposed error estimator 310 does not consume much time to converge the computation results. As shown from Eq. (22) to Eq. (25), the correction signals #ERR may be simply obtained by the multiplier and divider. In addition, in addition to correct the phase offset of the multiplex signal MPX, the proposed stereo audio decoder 300 may further eliminate the timing and frequency offsets. No low pass filter as the LPF 114 shown in FIG. 1 is required to be disposed at the output of the channel separator 112.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A stereo audio decoder for decoding a multiplex signal into a stereo audio signal, comprising:
a first filter module, filtering the multiplex signal to generate a summation signal;
a sub-carrier module, modulating the multiplex signal according to a sub-carrier frequency to generate a sub-carrier mixed signal comprising a first high frequency component and a first low frequency component, wherein the first low frequency component comprises a sub-carrier phase offset between the stereo audio decoder and the multiplex signal;
a second filter module, coupled to the sub-carrier module and filtering out the first high frequency component of the sub-carrier mixed signal to generate a sub-carrier pure signal comprising only the first low frequency component;
a corrector, generating a difference signal according to a correction signal and the multiplex signal; and
a channel separator, coupled to the first filter module and the corrector and obtaining a left channel signal and a right channel signal of the stereo audio signal by decoding the summation signal and the difference signal.

2. The stereo audio decoder as claimed in claim 1, further comprising:
a pilot module, modulating the multiplex signal according to a pilot frequency to generate a pilot mixed signal comprising a second high frequency component and a second low frequency component, wherein the second low frequency component comprises a pilot phase offset between the stereo audio decoder and the multiplex signal;
a third filter module, coupled to the pilot module and filtering out the second high frequency component of the pilot mixed signal to generate a pilot pure signal comprising only the second low frequency component; and
an error estimator, coupled to the third filter module and detecting the pilot phase offset according to the pilot pure signal to generate the correction signal.

3. The stereo audio decoder as claimed in claim 2, wherein the pilot mixed signal comprises an in phase sub-carrier mixed signal and a quadrature phase sub-carrier mixed signal; and wherein the sub-carrier module comprises:
a sub-carrier generator, generating a first sine signal and a first cosine signal having the sub-carrier frequency;
a first multiplier, coupled to the sub-carrier generator and multiplying the first sine signal by the multiplex signal to generate the in phase sub-carrier mixed signal; and
a second multiplier, coupled to the sub-carrier generator and multiplying the first cosine signal by the multiplex signal to generate the quadrature phase sub-carrier mixed signal.

4. The stereo audio decoder as claimed in claim 3, wherein the sub-carrier pure signal comprises an in phase sub-carrier pure signal and a quadrature phase sub-carrier pure signal; and
the second filter module comprises tow low pass filters, coupled to the first multiplier and the second multiplier, respectively, to filter out the first high frequency component of the in phase sub-carrier mixed signal and the quadrature phase sub-carrier mixed signal and obtains the in phase sub-carrier pure signal and the quadrature phase sub-carrier pure signal.

5. The stereo audio decoder as claimed in claim 4, wherein the correction signal output by the error estimator comprises a sine compensation signal and a cosine compensation signal, and the corrector comprises:
a third multiplier, coupled to the second filter module and multiplying the cosine compensation signal by the in phase sub-carrier pure signal to generate an in phase sub-carrier compensation signal;
a fourth multiplier, coupled to the second filter module and multiplying the sine compensation signal by the quadrature phase sub-carrier pure signal to generate a quadrature phase sub-carrier compensation signal; and
an adder, adding the in phase sub-carrier compensation signal and the quadrature phase sub-carrier compensation signal to eliminate the sub-carrier phase offset and generate the difference signal.

6. The stereo audio decoder as claimed in claim 2, wherein the channel separator comprises:
an adder, coupled to the first filter module and the corrector, adding the summation signal and the difference signal to generate the left channel signal; and
a subtractor, coupled to the first filter module and the corrector and subtracting the summation signal from the difference signal to generate the right channel signal.

7. The stereo audio decoder as claimed in claim 2, wherein the pilot mixed signal comprises an in phase pilot mixed signal and a quadrature phase pilot mixed signal; and wherein the pilot module comprises:
a pilot signal generator, generating a second sine signal and a second cosine signal having the pilot frequency;
a first multiplier, coupled to the pilot signal generator and multiplying the second sine signal by the multiplex signal to generate the in phase pilot mixed signal; and
a second multiplier, coupled to the pilot signal generator and multiplying the second cosine signal by the multiplex signal to generate the quadrature phase pilot mixed signal.

8. The stereo audio decoder as claimed in claim 7, wherein the pilot pure signal comprises:
an in phase pilot pure signal and a quadrature phase pilot pure signal; and
the third filter module comprises two low pass filters, coupled to the first multiplier and the second multiplier, respectively, to filter out the second high frequency component in the in phase pilot mixed signal and the quadrature phase pilot mixed signal to obtain an in phase pilot pure signal and a quadrature phase pilot pure signal of the pilot pure signal.

9. The stereo audio decoder as claimed in claim 8, wherein the correction signal comprises a cosine compensation signal and a sine compensation signal, the error estimator receives the in phase pilot pure signal and the quadrature phase pilot pure signal and obtains a sum of squares, a difference of squares and a product thereof, divides the difference of squares by the sum of squares to generate the cosine compensation signal, and divides the product by the sum of squares to generate the sine compensation signal, wherein a frequency of the cosine compensation signal and the sine compensation equals to the sub-carrier phase offset, and the pilot frequency is half of the sub-carrier frequency.

10. A multiplex signal decoding method for decoding a multiplex signal into a stereo audio signal, wherein the multiplex signal comprises a baseband signal component, a sub-carrier signal component and a pilot signal component, comprising:
low pass filtering the multiplex signal to generate a summation signal comprising only the baseband signal component;
modulating the multiplex signal according to a sub-carrier frequency to generate a sub-carrier mixed signal comprising a first high frequency component and a first low frequency component, wherein the first low frequency component comprises a sub-carrier phase offset between the sub-carrier signal component and the sub-carrier frequency;
filtering out the first high frequency component to generate a sub-carrier pure signal comprising only the first low frequency component;
eliminating the sub-carrier phase offset of the sub-carrier pure signal according to a correction signal to generate a difference signal; and
obtaining a left channel signal and a right channel signal by decoding the stereo audio signal according to the summation signal and the difference signal.

11. The multiplex signal decoding method as claimed in claim 10, wherein the correction signal is generated by:
modulating the multiplex signal according to a pilot frequency to generate a pilot mixed signal comprising a second high frequency component and a second low frequency component, wherein the second low frequency component comprises a pilot phase offset between the pilot signal component and the pilot frequency;
filtering out the second high frequency component to generate a pilot pure signal comprising only the second low frequency component; and
detecting the pilot phase offset according to the pilot pure signal to generate the correction signal.

12. The multiplex signal decoding method as claimed in claim 11, wherein the step of modulating the multiplex signal according to the sub-carrier frequency further comprises:
providing a first sine signal and a first cosine signal having the sub-carrier frequency;
multiplying the first sine signal by the multiplex signal to generate an in phase sub-carrier mixed signal; and
multiplying the first cosine signal by the multiplex signal to generate a quadrature phase sub-carrier mixed signal.

13. The multiplex signal decoding method as claimed in claim 12, wherein the step of filtering out the first high frequency component of the sub-carrier mixed signal further comprises filtering out the first high frequency component of the in phase sub-carrier mixed signal and the quadrature phase sub-carrier mixed signal to obtain an in phase sub-carrier pure signal and a quadrature phase sub-carrier pure signal of the sub-carrier pure signal.

14. The multiplex signal decoding method as claimed in claim 13, wherein the correction signal comprises a sine compensation signal and a cosine compensation signal, and the step of eliminating the sub-carrier phase offset of the sub-carrier pure signal further comprises:
multiplying the cosine compensation signal by the in phase sub-carrier pure signal to generate an in phase sub-carrier compensation signal;
multiplying the sine compensation signal by the quadrature phase sub-carrier pure signal to generate a quadrature phase sub-carrier compensation signal; and
adding the in phase sub-carrier compensation signal and the quadrature phase sub-carrier compensation signal to eliminate the sub-carrier phase offset and generate the difference signal.

15. The multiplex signal decoding method as claimed in claim 11, wherein the step of decoding the stereo audio signal according to the summation signal and the difference signal further comprises:
adding the summation signal and the difference signal to generate the left channel signal; and
subtracting the summation signal from the difference signal to generate the right channel signal.

16. The multiplex signal decoding method as claimed in claim 11, wherein the step of modulating the multiplex signal according to the pilot frequency further comprises:
providing a second sine signal and a second cosine signal having the pilot frequency;
multiplying the second sine signal by the multiplex signal to generate an in phase pilot mixed signal; and
multiplying the second cosine signal by the multiplex signal to generate the quadrature phase pilot mixed signal.

17. The multiplex signal decoding method as claimed in claim 16, wherein the step of filtering out the second high frequency component further comprises filtering out the second high frequency component in the in phase pilot mixed signal and the quadrature phase pilot mixed signal to obtain an in phase pilot pure signal and a quadrature phase pilot pure signal of the pilot pure signal.

18. The multiplex signal decoding method as claimed in claim 17, wherein the correction signal comprises a sine compensation signal and a cosine compensation signal, and the correction signal is generated by:
obtaining a sum of squares, a difference of squares and a product of the in phase pilot pure signal and the quadrature phase pilot pure signal;
dividing the difference of squares by the sum of squares to generate the cosine compensation signal; and
dividing the product by the sum of squares to generate the sine compensation signal,
wherein a frequency of the cosine compensation signal and the sine compensation equals to the sub-carrier phase offset, and the pilot frequency is half of the sub-carrier frequency.
